(19) United States
(12) Patent Application Publication
(10) Pub. No.: US 2011/0238490 A1
(43) Pub. Date: Sep. 29, 2011

(54) AUCTION FLIGHTING

(75) Inventors: Patrice Y. Simard, Bellevue, WA (US); David M. Chickering, Bellevue, WA (US); Denis X. Charles, Bellevue, WA (US)

(73) Assignee: Microsoft Corporation, Redmond, WA (US)

(21) Appl. No.: 12/732,031

(22) Filed: Mar. 25, 2010

(51) Int. Cl. G06Q 30/00; G06Q 10/00

(52) U.S. Cl. 705/14.43; 705/14.46; 705/14.54; 705/14.71; 705/26.3

(57) ABSTRACT

Various embodiments provide techniques for auction flighting. In one or more embodiments, a control group and a test group are designated for participants who compete one to another in online auctions. An inclusive model may then be employed for testing of new conditions for auctions using the groups. In particular, multiple auctions can be conducted and/or simulated, such that control conditions are applied in auctions that do not include at least one member of the test group, and test conditions are applied in auctions having members from both the test group and the control group. A response to the test conditions can then be measured by analyzing behaviors of the participants in the auctions conducted with the control conditions in comparison to behaviors of participants in the auctions conducted with the test conditions.

### BACKGROUND

In many scenarios it can be desirable for a service provider to perform controlled experiments to test parameter settings and configurations within a resource delivery system. An example of such a scenario is in the context of auctions that are conducted with advertisers to compete for advertising space that may be used to display ads in conjunction with webpages and/or other resources available via the service provider. Controlled experiments for auctions may be referred to herein as “Auction Flighting” and may be used to improve pricing, matching, and/or user experiences of participants in auctions.

Traditionally, controlled experiments may be performed on a small portion of traffic, such as testing with a subset of the advertisers or testing with a random sample of ad impressions in an ad delivery system. Experiments conducted on a subset or random sampling of auction participants, though, may not be able accurately measure behavior in auctions because participants respond not only to the auction parameters, but also to actions of other participants competing in the auction. Removal of some participants from the competition for a test auction causes “thinning” of the market and/or may cause other changes to the market that affect the behavior of participants in the auction. Thus, it may be difficult to partition auction participants in a manner that enables accurate modeling of participant response to a new configuration.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide techniques for auction flighting. In one or more embodiments, a control group and a test group are designated for participants who compete one to another in online auctions. An inclusive model may then be employed for testing of new conditions for auctions using the groups. In particular, multiple auctions can be conducted and/or simulated, such that control conditions are applied in auctions that do not include at least one member of the test group, and test conditions are applied in auctions having members from both the test group and the control group. A response to the test conditions can then be measured by analyzing behaviors of the participants in the auctions conducted with the control conditions in comparison to behaviors of participants in the auctions conducted with the test conditions.

### BRIEF DESCRIPTION OF THE DRAWINGS

FIG. 1 illustrates an example operating environment in which one or more embodiments of auction flighting can be employed.

FIG. 2 is a flow diagram that describes an example procedure in accordance with one or more embodiments.

FIG. 3 is a flow diagram that describes another example procedure in accordance with one or more embodiments.

FIG. 4 is a diagram that depicts an example advertiser response in accordance with one or more embodiments.

FIG. 5 is a diagram that depicts a disjoint model for auction flighting in accordance with one or more embodiments.

FIG. 6 is a diagram that depicts an example advertiser response using a disjoint model in accordance with one or more embodiments.

FIG. 7 is a diagram that depicts a comparison of partitioning between a disjoint model and an inclusive model for auction flighting in accordance with one or more embodiments.

FIG. 8 is a diagram that depicts an inclusive model for auction flighting in accordance with one or more embodiments.

FIG. 9 is a diagram that depicts an example advertiser response using an inclusive model in accordance with one or more embodiments.

FIG. 10 is a diagram that depicts partitioning for an extended inclusive model for auction flighting in accordance with one or more embodiments.

FIG. 11 is a diagram that depicts an extended inclusive model in accordance with one or more embodiments.

FIG. 12 is a diagram that depicts an example auction-participation graph in accordance with one or more embodiments.

FIG. 13 is a block diagram of a system that can implement the various embodiments.

### DETAILED DESCRIPTION

Overview

Various embodiments provide techniques for auction flighting. In one or more embodiments, a control group and a test group are designated for participants who compete one to another in online auctions. An inclusive model may then be employed for testing of new conditions (e.g., a treatment) for auctions using the groups. In particular, multiple auctions can be conducted and/or simulated, such that control conditions are applied in auctions that do not include at least one member of the test group, and test conditions are applied in auctions having members from both the test group and the control group. A response to the test conditions can then be measured by analyzing behaviors of the participants in the auctions conducted with the control conditions in comparison to behaviors of participants in the auctions conducted with the test conditions.

In the discussion that follows, a section entitled “Operating Environment” describes but one environment in which the various embodiments can be employed. Following this, a section entitled “Auction Flighting Procedures” describes example techniques and algorithms for auction flighting in accordance with one or more embodiments. Next, a section entitled “Auction Flighting Implementation Details” describes example implementations of auction flighting techniques in accordance with one or more embodiments. Last, a section entitled “Example System” is provided and describes an example system that can be used to implement one or more embodiments.

Operating Environment

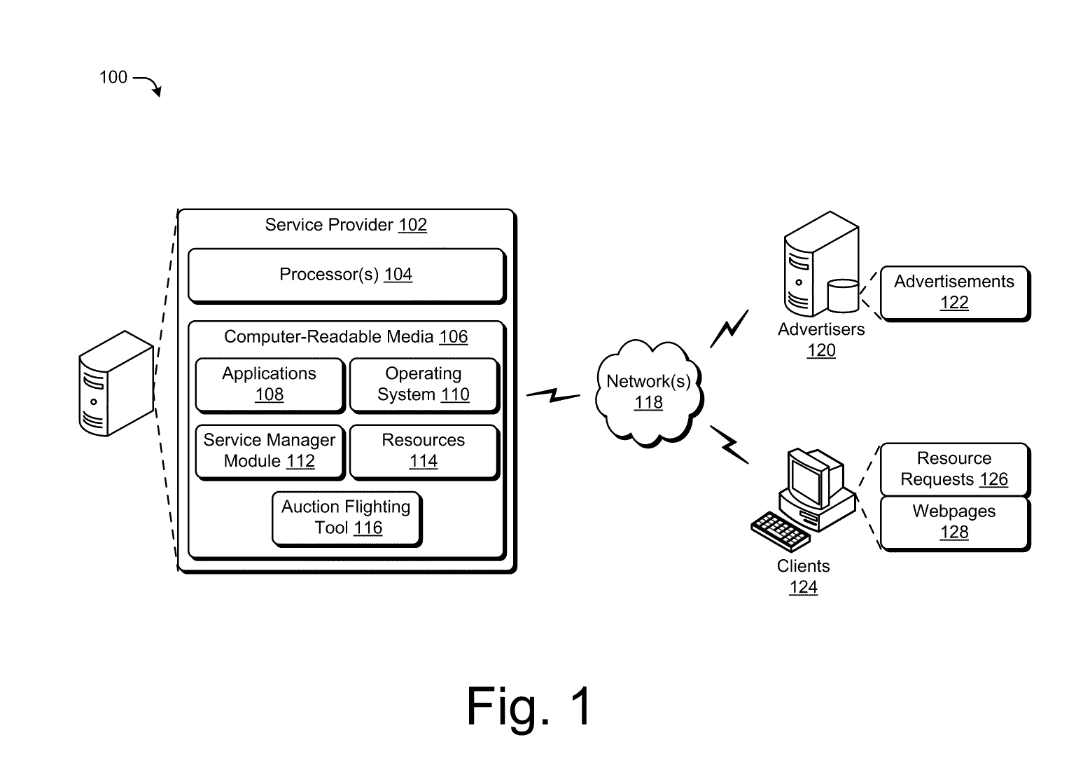

FIG. 1 illustrates an operating environment in accordance with one or more embodiments, generally at 100. Environment 100 includes a service provider 102 having one or more processors 104, one or more computer-readable media 106 and one or more applications 108 that are stored on the computer-readable media and which are executable by the one or more processors 104. The computer-readable media 106 can include, by way of example and not limitation, all forms of volatile and non-volatile memory and/or storage media that are typically associated with a computing device. Such media can include ROM, RAM, flash memory, hard disk, optical disks, removable media, and the like. Computer-readable media 106 is also depicted as storing an operating system 110, a service manager module 112, resources 114 (e.g., content, services, and data), and an auction flighting tool 116 that may also be executable by the processor(s) 104. While illustrated separately, the auction flighting tool 116 may also be implemented as a component of the service manager module 112.

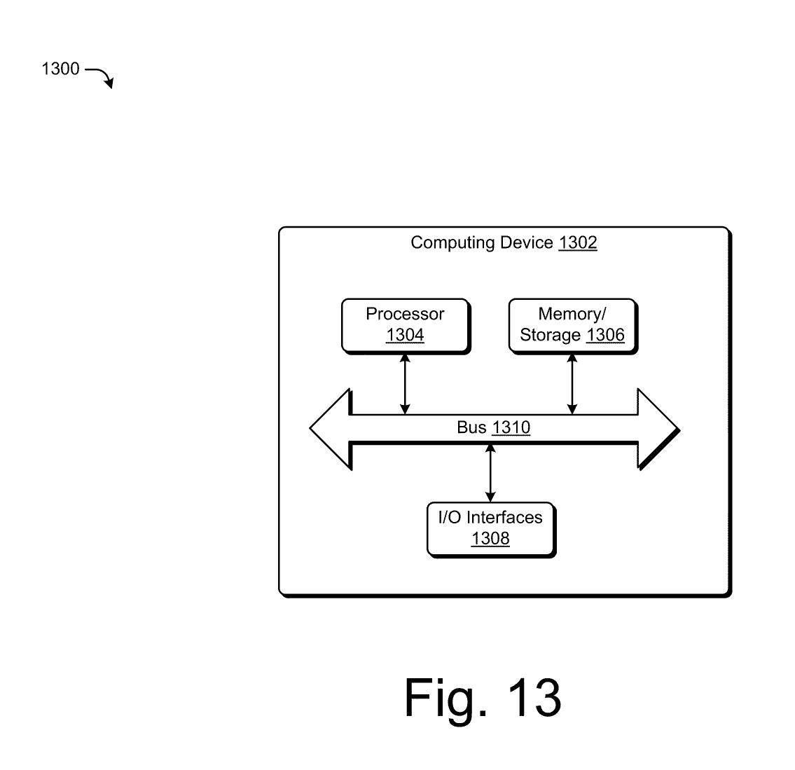

Service provider 102 can be embodied as any suitable computing device or combination of devices such as, by way of example and not limitation, a server, a server farm, a peer-to-peer network of devices, a desktop computer, and the like. One specific example of a computing device is shown and described below in relation to FIG. 13. Service provider 102 can be communicatively coupled over a network 118 to various other entities (e.g., devices, servers, storage locations, clients, and so forth). In particular, service provider 102 is illustrated as being connected over the network 118 to advertisers 120 that provide advertisements 122 and clients 124. Advertisers 120 and clients 124 may interact over the network 118 with the service provider 102 to obtain access to various resources 114. Although the network 118 is illustrated as the Internet, the network may assume a wide variety of configurations. For example, the network 118 may include a wide area network (WAN), a local area network (LAN), a wireless network, a public telephone network, an intranet, and so on. Further, although a single network 118 is shown, the network 118 may be configured to include multiple networks.

Service manager module 112 represents functionality operable by service provider 102 to manage various resources 114 that may be made available over the network 118. Service manager module 112 may manage access to the resources 114, performance of the resources 114, configuration of user interfaces or data to provide the resources 114, and so on. For example, clients 124 may form resource requests 126 for communication to the service provider 102 to obtain corresponding resources 114. In response to receiving such requests, service provider 102 can provide various resources 114 via webpages 128 or other user interfaces that are communicated over the network 118 for output by the one or more clients 124.

Resources 114 can include any suitable combination of content and/or services typically made available over a network by one or more service providers. Content can include various combinations of text, video, ads, audio, multi-media streams, animations, images, and the like. Some examples of services include, but are not limited to, a search service, an email service to send and receive email, an instant messaging service to provide instant messages between clients, and a social networking service to facilitate connections and interactions between groups of users who share common interests and activities. Services may also include an advertisement service configured to enable advertisers 120 to place advertisements 122 for presentation to clients 104 in conjunction with resources 114.

For instance, at least some of the webpages 128 can be configured to include advertisements 122 provided by the advertisers 120. Advertisements 122 may be selected for inclusion in webpages through an advertisement service using any suitable techniques for selection and delivery of the ads. In one example, auctions may be conducted for space that is reserved in a webpage 128 for advertisements 122 from the advertisers 120.

The auction flighting tool 116 is configured to implement aspects of auction flighting techniques described herein. Auction flighting tool 116 may be configured to selectively manage conditions for auctions (e.g., flighting) that are conducted online in a live setting and/or auctions that are conducted offline through an offline platform that uses predictive models for behaviors of participants (e.g., clients, service providers, advertisers, and so forth). The offline platform and behavior modeling may be used to cheaply and quickly examine possible test configurations without disturbing the actual market. It is contemplated, though, that auction flighting techniques described herein may be applied in both online and offline settings.

In particular, the auction flighting tool 116 represents functionality operable to enable flighting experimentation on participants in auctions, such as advertisers 120 who compete in auctions for advertising space reserved in webpages 128. In general, flighting experimentation refers to exposing a test group of participants to a test configuration (e.g., a set of test conditions, parameters, interfaces, and so forth) to determine a response of the participants to the test configuration. This may include partitioning of participants into designated groups, selectively applying test conditions to the groups during auctions (online and/or offline), collecting data indicative of participant's behavior in the auctions, and analyzing the collected data to measure an expected response to the test conditions. In at least some embodiments, the auction flighting tool 116 can be configured to implement an inclusive model in which control conditions and test conditions are exposed to the designated groups in an overlapping manner. By so doing, the effects of market thinning can be controlled to more closely predict an actual market response to the test configuration. Other models, such as a disjoint model are also contemplated. Further discussion and details regarding operation of an auction flighting tool 116 and different models for auction flighting techniques can be found in relation to the following figures.

Having considered an example operating environment, consider now a discussion of example auction flighting techniques in accordance with one or more embodiments.

Auction Flighting Procedures

The following discussion describes auction flighting techniques that may be implemented utilizing the environment, systems, and/or devices described above and below. Aspects of each of the procedures below may be implemented in hardware, firmware, software, or a combination thereof The procedures are shown as a set of blocks that specify operations performed by one or more devices and are not necessarily limited to the orders shown for performing the operations by the respective blocks. In portions of the following discussion, reference may be made to the example environment 100 of FIG. 1.

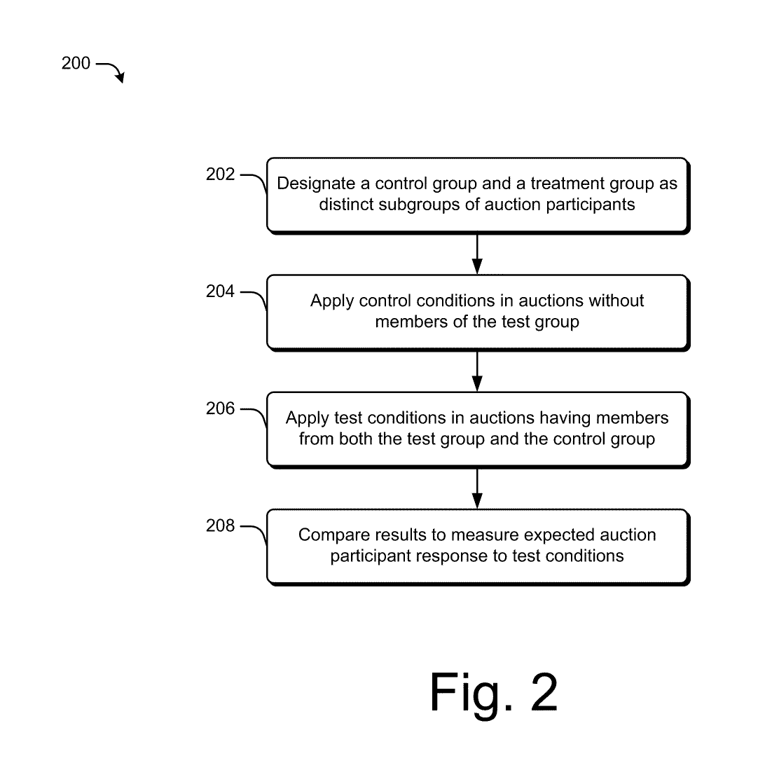

FIG. 2 is a flow diagram that describes an example procedure 200 in accordance with one or more embodiments. In at least some embodiments, the procedure 200 can be performed by a suitably configured service provider, such as a service provider 102 of FIG. 1 having an auction flighting tool 116.

Step 202 designates a control group and a treatment group as distinct subgroups of auction participants. In particular, a service provider 102 may use data that describes participation of participants one to another in auctions to derive suitable groups to partition the participants. In at least some embodiments the participants are advertisers who compete one to another for advertising space from the service provider. One way that groups can be formed is by operation of an auction flighting tool 116 of FIG. 1. The auction flighting tool 116 can make use of the groups to selectively expose different sets of conditions for auctions (also referred to herein as “configurations” or “treatments”) to the different groups. Then, the manner in which participants behave under the differing conditions can be examined to determine the effect that changes in the conditions have on participant behavior.

Various conditions for an auction are contemplated that may be set to control the auction. Auction conditions correspond to particular settings for one or more configurable settings for the auction. Examples of such configurable settings for the online auctions include, but are not limited to, a minimum price, a maximum price, a reserve price, a starting price, a bid increment, number of participants, a time period for the auction, automatic bid settings, an auction type, or a number of bids allowed per bidder.

Consider an example in which a service provider would like to examine participant response to a test treatment that is defined by a set of test conditions relative to a control configuration for the auction that is defined by a set of control conditions. To conduct an experiment, auction flighting tool 116 is operable to set the test conditions and control conditions to define the test treatment and the control configuration, respectively. During online and/or simulated auctions, auction flighting tool 116 may selectively expose the test treatment or the control configuration depending upon the make-up of participants in the auction. For example, conditions that are selected for an auction can be based upon which groups have members participating in the auction.

In at least some embodiments, the auction flighting tool 116 is configured to make use of an inclusive model that is discussed in greater detail in the examples below. Under the inclusive model, the auction flighting tool 116 exposes at least some members of the control group to the test treatment in at least some auctions in order to remove the effects of thinning to the extent possible.

For instance, step 204 applies control conditions in auctions without members of the test group. This may occur during online and/or simulated auctions that do not involve members from the test group. Step 206 applies test conditions in auctions having members from both the test group and the control group. Accordingly, the test group is exposed to the test conditions. The control group, though, is exposed to overlapping auction conditions. In other words, the control group sees the test treatment in auctions with the test group and sees the control configuration in auctions when members of the test group do not participate.

In some instance, auctions can be run repeatedly using test conditions and control conditions in different runs to determine if control conditions can be used as substitute for the test conditions. For example, suppose there is at least one member of the test group participating in an auction. If the test conditions are applied and a member of the test group does not “win” the auction (e.g., an advertisement corresponding to a member of the test group is not shown on the page), the auction can be run again this time using the control conditions. If again, a member of the test group does not “win” the auction, control conditions can be substituted for the control conditions. In this scenario, the control group sees the control conditions and the test group sees the same thing as they would have seen if the test conditions were applied. This technique can be employed in instances where members of the treatment group participate in a lot of auctions in which they lose out to members of the control group.

In step 208, results of auctions are compared to measure an expected auction participant response to the test conditions. For example, auction flighting tool 116 may be configured to collect data indicative of behaviors of the auction participants in auctions under both the test conditions and the control conditions. This can include storing data related to multiple auctions. The auction flighting tool 116 can also be configured to compare the behaviors of the ad auction participants under the test conditions and the control conditions to analysis how the ad auction participants respond to the test conditions. Additional details regarding measuring auction participant response to test conditions can be found below in the section below entitled “Auction Flighting Implementation Details.”

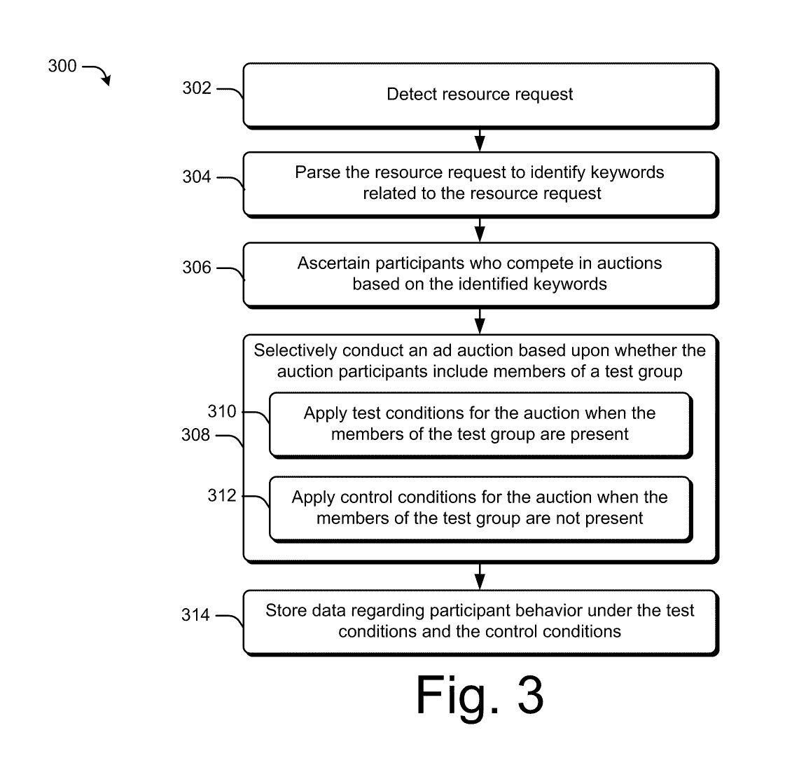

FIG. 3 is a flow diagram that describes an example procedure 300 in accordance with one or more embodiments. In at least some embodiments, the procedure 300 can be performed by a suitably configured service provider, such as a service provider 102 of FIG. 1 having an auction flighting tool 116. In particular, FIG. 3 depicts a procedure in which auction flighting can be performed responsive to a resource request 126. Portions of procedure 300 are described in relation to an example auction between advertisers for ad space that may be used to present ads to clients in conjunction with requested resources.

Step 302 detects a resource request. In an online “live” auction setting, resource requests 126 may be obtained by a service provider from clients 124. When an offline platform is employed for flighting experiments, auction flighting tool 116 can be configured to simulate resource requests to initiate auctions for advertising space that is associated with requested resources 114. Various different types of requests are contemplated. For example, a request may be associated with various resources 114 that are available from the service provider 102 of FIG. 1. In one or more embodiments, the service provider 102 can provide a search service that is made available over the network 118 to the clients 124. In this context, resource requests 126 may correspond to search queries made by clients 124 to obtain search results through the search service. Other requests are also contemplated, such as requests associated with email service or instant messaging, requests for multimedia content, requests to obtain resources for a desktop application of a client 124, and so forth. Requests may initiate a corresponding auction to sell reserved space for advertisements in webpages 128 that are used to deliver requested resources to clients 124.

Step 304 parses the resource request to identify keywords related to the resource request. For instance, auction flighting tool 116 may be configured to intercept a request and identify keywords from the request. The identified keywords may then be used to select participants for an auction.

Various keywords may be derivable from resource requests 126. In a sponsored model for provision of resources 114 from a service provider 102, advertisers may be selectively associated with various keywords that may be contained in or otherwise determined based upon requests from clients 124. The keywords in this example can correspond to search terms input via a browser of a client 124. By associating with keywords, the advertiser signals that they would like to compete in ad auctions related the identified keywords. In the example above of search queries, a client 124 may conduct a search for “digital cameras” using the search service. One or more advertisers 120 who are merchants of cameras and/or camera accessories may be interested in targeting ads to the client 124 based on the search. By associating with the keywords “digital” and “cameras,” these advertisers are selected to compete for ad space associated with the example search for “digital cameras.”

In particular, step 306 ascertains participants who compete in auctions based on the identified keywords. For instance, auction flighting tool 116 can extract keywords from the request and match the keywords to advertisers 120 who are associated with the keywords. Advertisers who match the keywords are selected as participants for auctions initiated in response to the request.

Step 308 selectively conducts an auction based upon whether participants include members of a test group. In particular, step 310 applies test conditions for the auction when the members of the test group are present, and step 312 applies control conditions for the auction when the members of the test group are not present. The winner or winners of the auctions may then have their ads shown (e.g., displayed) in conjunction with resources 114 that are provided to the client 124 through webpages 128, or otherwise.

Step 314 stores data regarding participant behavior under the test conditions and the control conditions. For example, auction flighting tool 116 may collect various data during a series of auctions. This may include measuring various key performance indicators (KPIs) over time. Some examples of KPIs that may be measured include revenue, return on investment (ROI), and average revenue per participant. Collected data may also be related to participants' behavior. For example, changes in participant tactics, such as bid increments, bid frequency, starting bid, and so forth, can be tracked during the auctions. The auction flighting tool 116 can collect the data for both auctions having the test conditions and auctions having the control conditions. The data may be stored in any suitable storage including storage on computer-readable media 106 associated with a service provider 102. The data that is collected and/or stored may then be analyzed to measure a response to the test conditions. For instance, a comparison of KPIs and/or participant behaviors in auctions having the test conditions and auctions having the control conditions can be made to understand the effects of the test conditions on the auctions.

Having described example procedures involving auction flighting, consider now specific implementation examples that can be employed with one or more embodiments described herein.

Auction Flighting Implementation Examples

In the discussion that follows in this section, a general discussion of auction flighting is first provided for context. Then a comparison is made between different models that may be used to implement auction flighting techniques described herein. Next, details are given regarding an inclusive model for auction flighting followed by a discussion of an extended version of the inclusive model. Finally, a discussion of partitioning techniques that may be employed to designate control groups and test groups for the purpose of auction flighting is provided.

As noted above, controlled experiments to test parameter settings within an ad delivery system are typically performed on a small portion of traffic. For instance, testing may be conducted with a small subset of participants or testing with a small random sample of inventory (e.g., ad impressions in the case of ad auctions). Existing techniques to test system configurations are sufficient to measure the effect of the changes on client behavior. However, it may be difficult to measure a response of auctions participants. In particular, individual participants can be “protected” from the experiment because they participate in a small portion of auctions. Thus, only some of the auctions in which a participant competes will be affected.

Using an off-line experimentation platform can remove this limitation by modeling the behavior of the different players in the ecosystem. To build an accurate ecosystem model, models are constructed for the different participants. In a sponsored resource setting, this can include users (e.g., clients), auction participants (e.g., advertisers), and service providers. The user models predict user utilities as functions of measurable quantities (e.g., pClick, conversion, dwell time, return rate, session lengths, etc). The user models can be validated using existing techniques for flighting treatments to users and/or historical data that is compiled by a service provider. Additionally, a service provider generally has ample information regarding their own behavior, and therefore the model of service provider behavior can be considered a known quantity. A challenging aspect of building an accurate ecosystem model is validating auction participant models.

As noted above, flighting generally involves selectively exposing differing treatments to different groups of users or participants. In an ad auction example, this may corresponds to using control conditions in some ad auctions and test conditions in other auctions. The conditions that are used may depend upon which participants are included in the auction.

To illustrate, assume a control configuration TO that is defined by a set of control conditions and is typically used for ad auctions between advertisers. A service provider may wish to model an advertiser response assuming that a test treatment T1 is deployed to some subset of the advertisers. A traditional approach to this experiment is to (1) divide the advertisers into a control group A0 and a test group A1, (2) apply the control configuration T0 to the advertisers in A0 and the test treatment T1 to the advertisers in A1, and (3) compare the response of the A0 advertisers to the response of the A1 advertisers. Assuming the advertisers in A0 and A1 are representative of the advertisers targeted for the test treatment, and further assuming that the environments in which T0 and T1 are applied are representative of the pre-treatment and post-treatment environments, respectively, then differences in a response between the two groups can be attributed to the different conditions for the control configuration and the test treatment. Note that although dividing “advertisers” into the groups A0 and A1 is discussed, it is also possible to divide ad campaigns or ad groups in a similar way. More generally, participants in various different kinds of auctions can be divided in a similar manner. Generally, division or partitioning occurs such that participants belonging to different groups are being optimized independently of each other.

There can be two challenges when designing controlled experiments for auction participants. Both of these result from the interdependence between multiple participants participating in a common auction. The first challenge is that participants respond not just to the immediate treatments (e.g., raising reserve prices), but to the actions of the other participants to that same treatment (e.g., raising bids). Thus, the “difference in response” of an advertiser to some treatment T1 may be measured as a difference in the sequence of actions over time as participants react to each other.

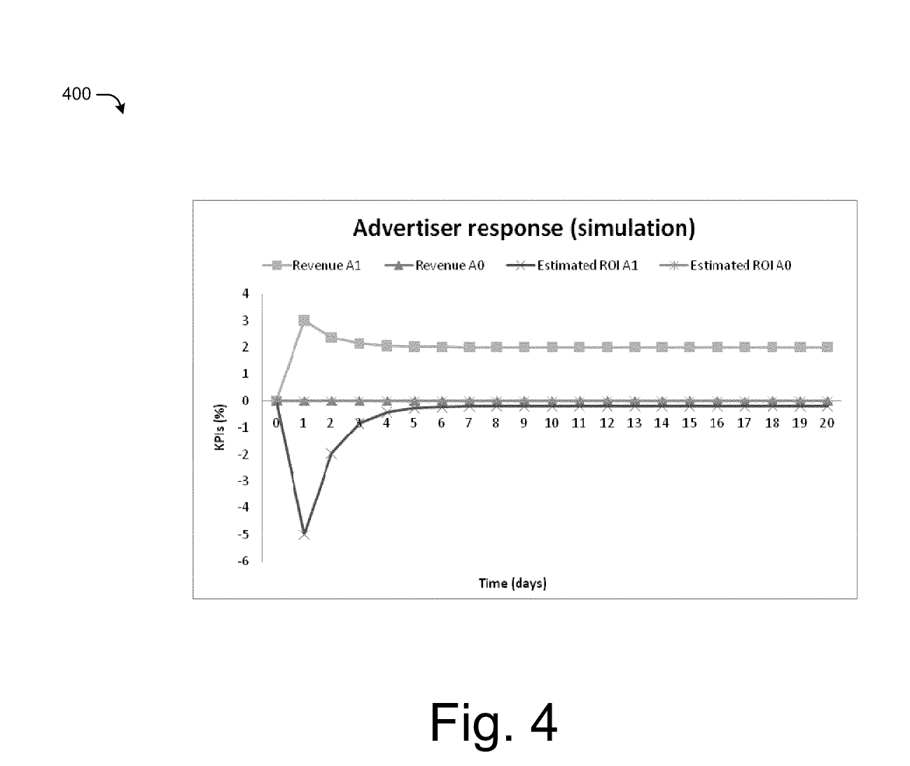

To further illustrate, consider now FIG. 4 which depicts generally at 400 an example response to a test treatment. The Y-axis represents the normalized version of some key performance indicator (KPI) that a service provider may want to measure through the experiments. By way of example, KPIs for ad auctions may include average revenue per advertiser or the average return on investment (ROI) per advertiser. The values are normalized with respect to the control group so that the control values are constant and the relative increase or decrease in the KPI for the participants in the treatment group is shown.

For the illustration, assume that individual participants optimize their tactics between discrete time steps, where at each time step they are allowed to submit changes to the auction system. At time t=0, both the A0 (control group) and the A1 (treatment group) see the control configuration T0. At time t=1, the test treatment T1 is applied to the A1 advertisers and the relative change in the KPI before advertisers have a chance to react is measured. At time t=2, participants can react to the test treatment (e.g., by changing bids) in the context of the original bids, resulting in a new relative KPI value. At subsequent time intervals, participants can react to each others' changes from previous intervals. The illustration suggests that the relative KPI is converging, perhaps due to the participants approaching an equilibrium. Because of the dynamics of participants responding to each other, measuring differences between the two groups may not be straightforward. It is expected, though, that participants will converge to some equilibrium after some fixed amount of time.

The second challenge when designing experiments for participants is that there is a tension between the following two desired properties of the experiment:
(1) “Separable”: participants in each group see their assigned treatment.
(2) “Representative”: participants in each group experience the same environment as they would were their treatment applied to the participant population as a whole.

Both of the above properties can hold is if there is a partitioning of participants into A0 and A1 such that no participant in A0 competes with any participant in A1 within any auction in the ad auction system. To understand this, consider any auction that contains a participant from both sets. In order to satisfy the separable property, the two cannot compete in this auction, but if one of them is removed from the competition, the market is “thinned” and the representative property is violated. Even if a “perfect” partitioning of the advertisers exists, a group resulting from the partitioning may not be suitable for experimentation if the group contains a large number advertisers or correspond to a relatively high a percent of a service provider's ad volume or revenue.

Having considered the challenges associated with partitioning groups in a manner that produces acceptable experiments, the discussion now turns to describing techniques that can be employed to identify suitable control and treatment groups under the assumption that the separable and representative properties cannot be simultaneously satisfied. Given the foregoing assumption, models to identify suitable control and treatment groups are considered for which the separable and/or representative properties “almost” hold.

The Disjoint Model

In this section, a disjoint model for explicitly retaining the separable property is discussed. In this model, participant dependence is eliminated by ensuring that control group A0 participants are given the control configuration T0 and test group A1 participants are given the T1 configuration. In other words, the participants in the control group and the test group receive exclusive treatments.

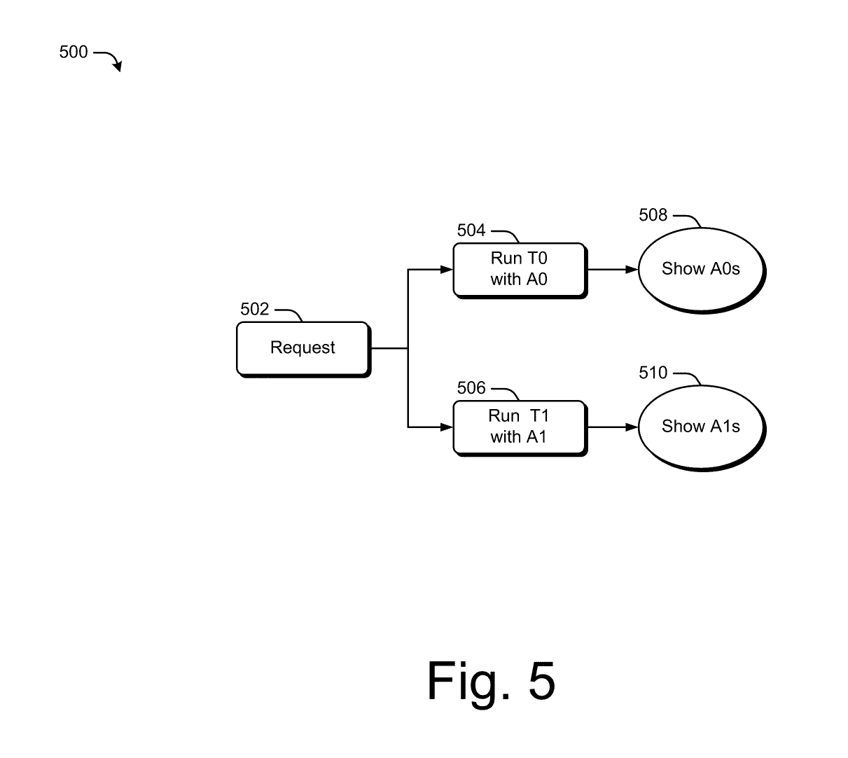

FIG. 5 depicts generally at 500 a representation of the disjoint model for auction flighting. Referring to FIG. 5, when a request 502 is submitted, one or both of the control configuration T0 and test treatment T1 are executed with the corresponding subsets A0 and A1 at blocks 504 and 506, respectively. In particular, when a resource request 126 is detected, participants (e.g., advertisers) associated with the request may be ascertained as described in relation to FIG. 3. Then, using the disjoint model an auction may be conducted using the control conditions T0 for participants in the control group A0. Another auction may be conducted for participants in the test group A1 using the test treatment T1. Thus, the auction conditions are divided exclusively between the groups. The result of one of the two auctions is shown at oval 508 or oval 510 (e.g., the one with highest revenue, or a perhaps T0 and T1 are picked randomly). A plurality of auctions may be conducted using corresponding conditions for the control group and test group, respectively.

Although the disjoint model insures independence, the model also restricts competition by preventing participants in A1 from competing with participants in A0. If A0 and A1 have been selected randomly, this can result in a global thinning of the market and a substantial change in the environment in which the A1 participants compete. Even with a careful selection of A0 and A1, it can be quite difficult to isolate a group of participants from the others without changing the group dynamic.

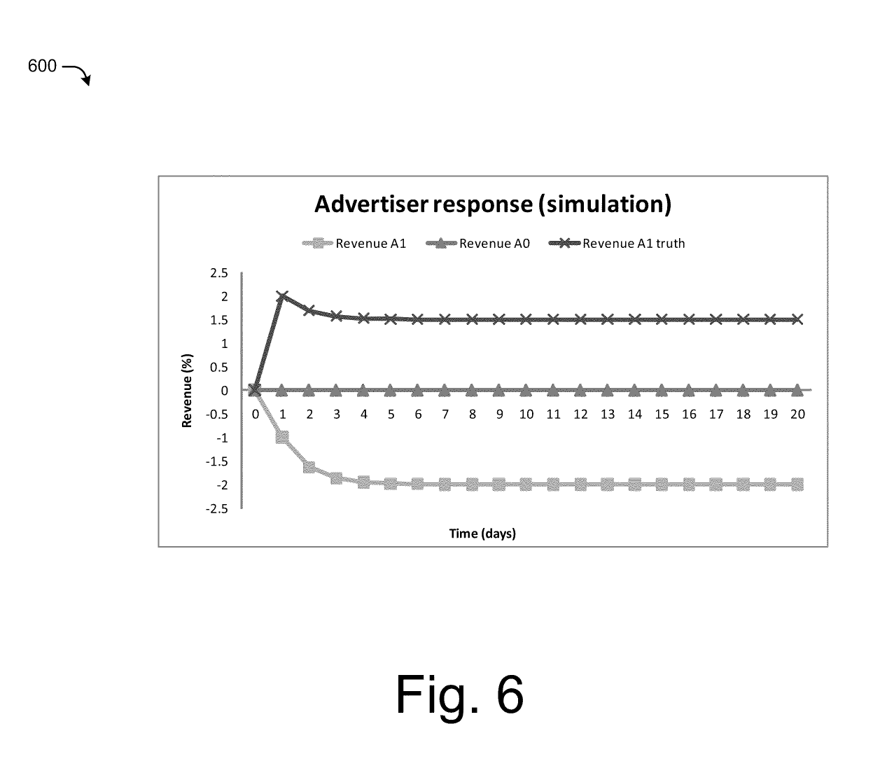

To illustrate how thinning can have an effect on the results of a controlled experiment, consider the first two responses in the normalized KPI graph of FIG. 4 for revenue, except now a “true” treatment value is included. FIG. 6 depicts generally at 600 an example response graph under the disjoint model. In this example, the KPI being measured is revenue. As noted, the graph of FIG. 6 includes revenue values predicted for a scenario in which the test treatment is applied to the entire population.

As illustrated at time t=1 in FIG. 6, under the disjoint auction model participants in the test group A1 actually see two treatments. That is, the test group A1 sees the intended treatment T1 plus the “thinning treatment” that results from removing the A0 competition. Thus, even if the A1 participants are a representative set, there will be a difference at time t=1 between the KPI measurements of the treatment group and the truth. In the example illustrated in FIG. 6, thinning has a significant negative impact on the KPI. At time t=2, participants react to the treatment given each others' bids at time t=1. Because of the thinning, the “thinned response” has a different effect on the measured KPI than the “true response.” This divergence is likely to continue after time t=1, given that the thinned market dynamic is likely to be different than the true dynamic. Because there are fewer participants, it may be assumed that the effect of participant response is more pronounced in a thinned market, as shown in the graph.

The Inclusive Model

In order to compensate for the effects of thinning, consider an alternative in which the separation property does not hold. This model is referred to herein as the inclusive model. Under the inclusive model a large fraction of auction participants are allowed to participate in both an experiment and its control. Again, the participants are divided into a control group A0 and the test group A1. The control configuration is still T0 and the test treatment is T1. However, the test treatment T1 is used for both A0 and A1, while the control configuration T0 is only used for A0. In other words the control group is exposed to overlapping auction conditions, e.g. both T0 and T1. This is in contrast to the disjoint model above where T1 was only used for A1.

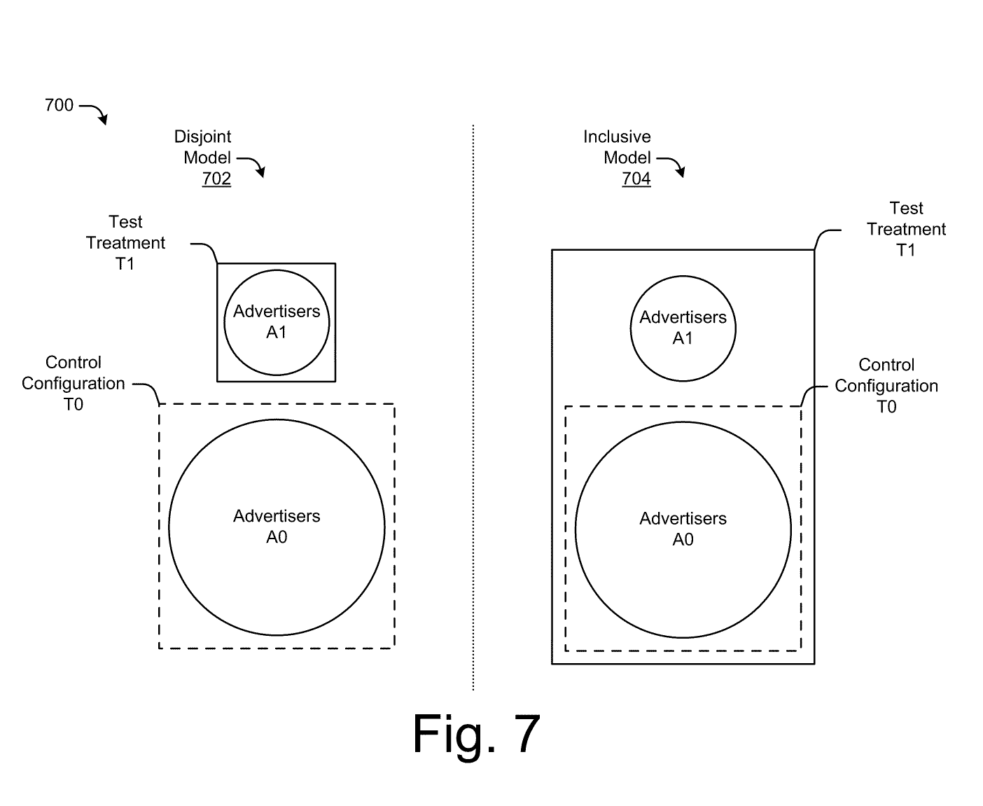

FIG. 7 depicts generally at 700 a comparison between the disjoint and inclusive models for auction flighting. The disjoint model 702 is illustrated on the left and the inclusive model 704 on the right. For the disjoint model 702, the test treatment T1 and control configuration T0 are applied exclusively. In particular, the test treatment T1 is applied to participants in the test group A1 and the control configuration T0 is applied to participants in the control group A0. The disjoint model is likely to result in some thinning and may be unrealistic for T1.

For the inclusive model 704, the test treatment T1 and control configuration T0 are applied in an overlapping manner. In particular, the control configuration T0 is applied to the control group A0. The test treatment T1, though, is applied to participants in both the test group A1 and control group A0. The auctions using the test treatment T1 derive thickness from the inclusion of A0. Auctions using the control configuration T0 also remain thick if the control group A0 is selected to be a large subset (e.g., 99%) of the participants.

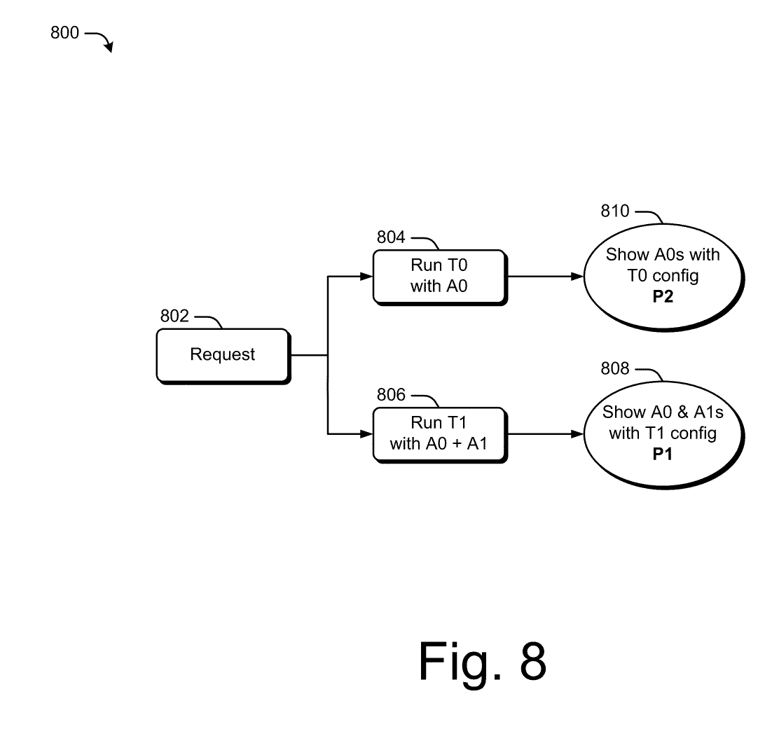

FIG. 8 depicts generally at 800 a computational representation of the inclusive model for auction flighting. In particular, responsive to a request 802 (e.g., a resource request 126) one or both of the control configuration T0 and test treatment T1 are executed with the corresponding participant subsets A0 and A1 at blocks 804 and 806, respectively. In particular, when a resource request 126 is detected, participants associated with the request may be ascertained as described in relation to FIG. 3. Then, using the inclusive model, an auction may be conducted using the control conditions T0 for participants in the control group A0. Another auction corresponding to the same or a different request may be conducted with participants in the test group A1 and with participants in the control group A0 using the test treatment T1. Thus, the auction conditions used in the inclusive model overlap with respect to the control group A0.

Priorities may be assigned to control which auction result is shown. For instance, a higher priority P1 is associated with the T1 auction and a lower priority P2 is associated with the T0 auction. If a participant from A1 is selected in the T1 auction, this is the auction that is shown (priority P1) at oval 808. If no participant in A1 is selected in the T1 auction, then the result of the T0 auction is shown (priority P2) at oval 810.

Note that the inclusive auction explicitly violates the separable property in order to retain market thickness for the test group A1. By including the control group A0 in T1 auctions, the representative property is also violated due to the fact that the control group A0 is receiving both treatments. Accordingly, responses from the control group A0 may not be representative for either treatment. In particular, participants in the control group A0 will optimize for a mixture of the two treatments that they receive.

To understand the consequences of these violations, consider the ratio r of (1) the number of A0 participations in auctions involving participants in A1 to (2) the total number of participations in the same auctions. The ratio r is referred to herein as the conductance value. For very small values of r (e.g., r very close to 0) the disjoint model and the inclusive model are (almost) equivalent and will both be appropriate for predicting ground truth. For very large values of r (e.g., r very close to 1), neither model will be appropriate for predicting ground truth. The disjoint model will have A1 auctions thinned considerably. The inclusive model will not allow accurate measurement of participant response due to the dominant presence of A0 participants.

For conductance values r between 0 and 1, the participant behavior of the disjoint model and the inclusive model are expected to be in between their corresponding extremes. Increasing the value of r is equivalent to changing the response of an increasing number of A0s in auctions involving A1. For the disjoint model, this is equivalent to forcing participants to under bid and effectively taking them out. For the inclusive model, it prevents participants from adapting to the market and thereby making them lazy or inefficient. While the “interpolation assumption” is not provable in general, it is likely to hold for treatments that are relatively stable with respect to participant responses. Under this assumption, it may be clear that the inclusive model may have certain advantages over the disjoint model. In particular, the inclusive model in operation dilutes the ground truth with an unresponsive model which is known, as opposed to diluting the ground truth with an unpredictable model as may be the case for the disjoint model. Nonetheless, it is contemplated that both the disjoint and inclusive models, as well as other models, may be employed to implement auction flighting techniques described herein in various embodiments It may also be clear that minimizing the conductance value r may produce a model that is closer to the ground truth.

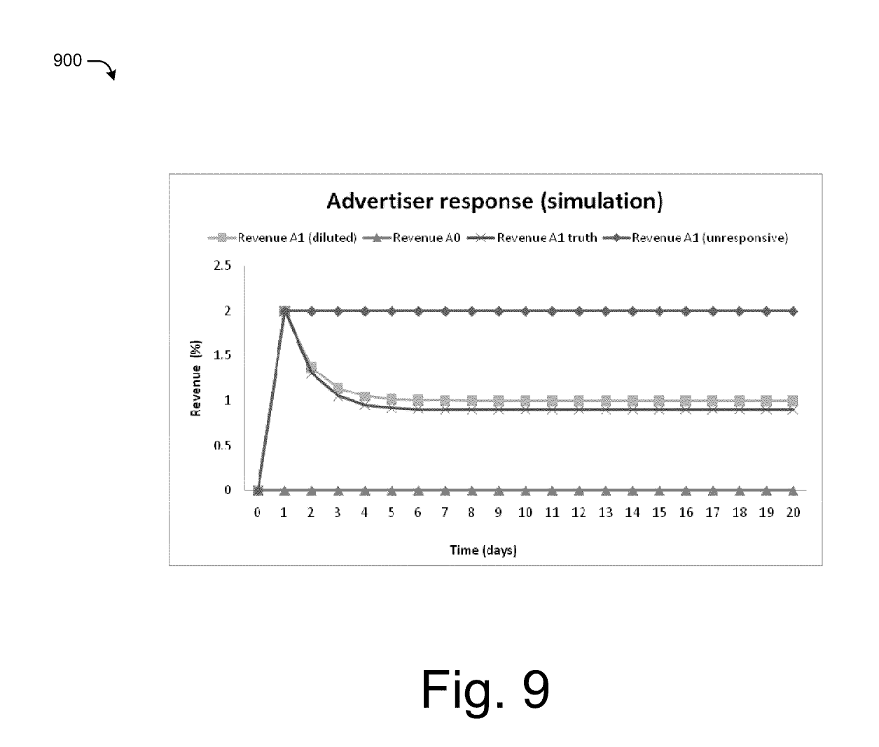

FIG. 9 depicts generally a 900 an advertiser response graph for the inclusive model. For the purpose of this example, assume that a control group and a test group are formed such that the conductance value r is relatively small. At time t=1, the test treatment T1 is applied to all auctions in which A1 participants participate. The ground truth denotes the predicted KPI assuming that the test treatment T1 was applied to everyone. The measured A1 revenue for the test group applies only to auctions involving A1 since both the ground truth and the treatment revenue are measured on A1, and because participants have not had a chance to respond to each others' bid changes. Accordingly, both curves yield the same value at time 1.

The KPI that is measured at time t=2 for the treatment group can differ from truth as a function of the number of bids from the control group A0. If most of the competition in the auction is from other test group A1 participants (e.g., conductance value r is small as assumed), the difference due to bids from the control group A0 can be kept relatively small. At subsequent time steps, the test group A1 participants will keep reacting mostly to each other. The test group effect will be diluted or dampened by a few members of the control group A0 that may not react to T1. In contrast, for the truth signal all the members of the control group A0 are assumed to be reacting to T1. For large conductance values r, the system could be unresponsive (flat line after time t=1) because the T1 treatment involves many unresponsive participants from A0. Thus, partitioning auction participants into groups such that the conductance value r is small can produce a suitable model that closely predicts the ground truth.

Extended Inclusive Model

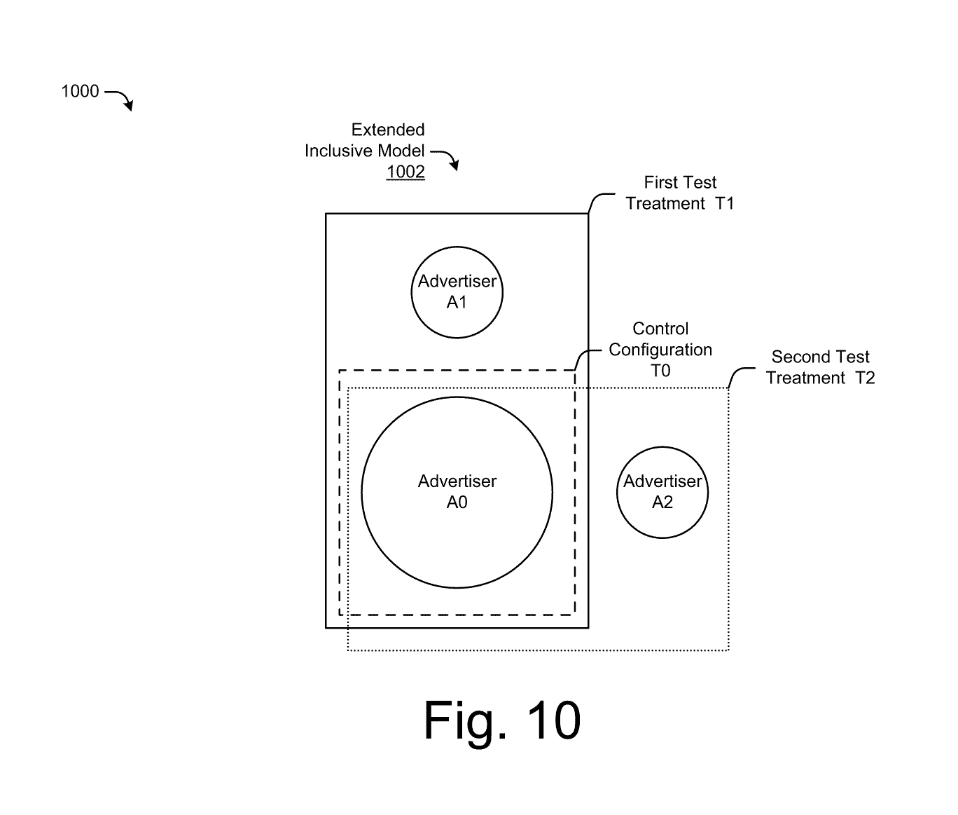

The inclusive model just described can be extended to test multiple test treatments. FIG. 10 depicts generally at 1000 an example illustration of an extended inclusive model 1002 for auction flighting. For the extended inclusive model, auction participants are partitioned into a control group A0, a first test group A1, and a second test group A2. Similarly, the model makes use of a control configuration T0, a first test treatment T1, and a second test treatment T2. Multiple treatments are examined by adding a second set of participants A2 having characteristics that are similar to A1. Comparative treatment testing enables comparisons of two or more test treatments simultaneously (e.g., two different reserve prices) without having to consider market fluctuations that might affect results. Further, if the target group of interest that is selected has certain characteristics (e.g., small market, international, regulated industry), control and treatment groups may be designated that have similar characteristics. In other words, the control group A0 has similar characteristics to the treatment group. Otherwise, the control group A0 may not be representative of the participants being targeted for the test treatment.

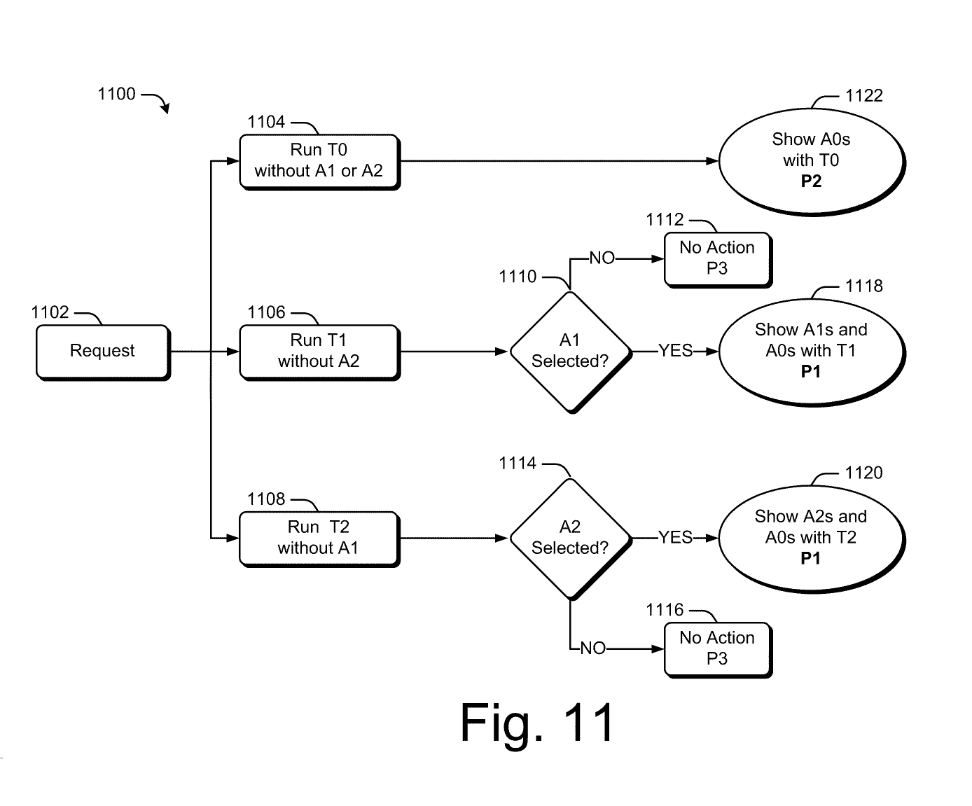

FIG. 11 depicts generally at 1100 a computational representation of the extended inclusive model for auction flighting. When a request 1102 is submitted, three auctions may be executed. In particular, the control configuration T0 is applied to participants the control group A0 at block 1104. The first test treatment T1 is applied to participants in the first test group A1 and to the control group A0 at block 1106. Likewise, the second test treatment T2 is applied to participants in the second test group A2 and to the control group A0 at block 1108. Priorities may again be assigned to the results of these three auction branches.

At block 1110 a determination as to whether a member of A1 appears in the results of T1 is made. If a member of A1 does not appear, then at block 1112 no action is taken with respect to the results of T1 (priority P3). Similarly, at block 1114 a determination as to whether a member of A2 appears in the results of T2 is made. If a member of A2 does not appear, then at block 1116 no action is taken with respect to the results of T2 (priority P3). If either a member of A1 appears in the results of T1 or a member of A2 appears in the results of T2, the results of the corresponding auction may be shown at block 1118 and block 1120, respectively (priority P1). In the event that both a member of A1 appears in the results of T1 and a member of A2 appears in the results of T2, then one of the results can be selected to be shown (priority P1). The selection can occur in any suitable way, including by random selection, timing, pre-designation, and so forth.

Recall that groups are formed such that the conductance value r is small. If A1 and A2 each represent 1% of the participants, the auction T0 has 98% of the participants, the auction T1 has 99% of the participants, and the auction T2 has 99% of the participants. Further, if A1 and A2 have similar characteristics, and if participants in A1 normally do not compete with participants in A2, T1 and T2 may be comparable groups. Note that this extended inclusive mode excludes A1 and A2 from being in the same auction. However, A1 represents a small percentage of A0, so the effect of removing A1 in T2 auctions on A2 is small. The same holds true for the effect of removing A2 in T1 auctions on A1. Note the difference from the disjoint auction model where a participant group is entirely cut-off from the rest of the participants.

Partitioning Auction Participants

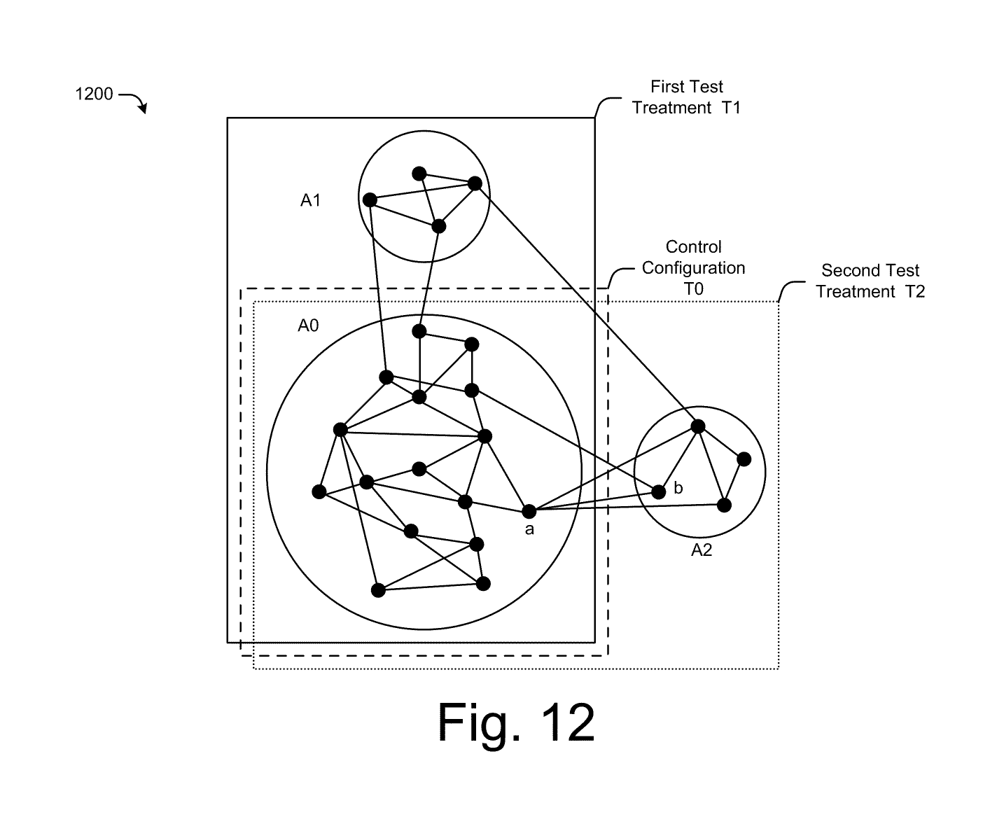

The discussion now turns to the problem of choosing a control and one or more test groups. Any suitable technique to derive groups can be employed with the described auction flighting techniques. In at least some embodiments, suitable groups can be formed by partitioning a graph configured to represent interactions between the participants in auctions. In the context of online auctions, the graph may be referred to as an “auction-participation graph.” An example of an auction-participation graph is described in greater detail just below in relation to FIG. 12. The partitioning of the graph may involve selecting the groups to optimize a number of interactions that occur between members of the control group and members in the test groups. In one example, the optimization corresponds to minimizing the conductance value r. Recall that the conductance value r is computed as a ratio of participations of members of the test group in the multiple auctions with members of the control group to a total number of participations in the multiple auctions.

As described earlier, groups used for auction flighting can be designated such that the groups “loosely” interact one to another. This may involve identifying mutually isolated sub-markets corresponding to the advertisers and forming the control group and test group according to the mutually isolated sub-markets. In this case, experimental results may closely model the true treatment that is the subject of the experiment. To further understand the problem, consider an example of the “auction-participation graph” introduced above. In this graph, nodes represent participants and edges between nodes indicate that the corresponding participants have competed in the same auction in some given duration of time. The edges in the auction-participation graph can optionally have weights that reflect the volume of auctions in which the participants compete or the amount of revenue produced by the auctions in which the participants compete.

FIG. 12 depicts generally at 1200 an example of an auction-participation graph. The test groups A1 and A2 in this example can be designated in a way that minimizes the edges weights between A1, A2, and A0. In graph theory, this task is called graph partitioning. Any suitable technique to partition a graph to form groups that are loosely related can be employed. One way in which suitable groups can be selected is to minimize the conductance value r between the clusters of participants in the auction-participation graph. Minimizing the conductance r is equivalent to minimizing the edges weights between the groups. Intuitively, this is equivalent to ensuring that whole vertical markets are included in A1 and A2. If the clusters are small enough, cluster vertical markets can be randomly assigned to A1 and A2 to ensure that the experimentation is unbiased.

Example System

FIG. 13 illustrates generally at 1300 an example computing device 1302 that may implement the various embodiments described above. The computing device 1302 may be, for example, a client 124 of FIG. 1, a server of a service provider 102, a server of an advertiser 120, or any other suitable computing device.

The computing device 1302 includes one or more processors or processing units 1304, one or more memory and/or storage components 1306, one or more input/output (I/O) interfaces 1308 for input/output (I/O) devices, and a bus 1310 that allows the various components and devices to communicate one to another. The bus 1310 represents one or more of several types of bus structures, including a memory bus or memory controller, a peripheral bus, an accelerated graphics port, and a processor or local bus using any of a variety of bus architectures. The bus 1310 can include wired and/or wireless buses.

The memory/storage component 1306 represents one or more computer storage media. The memory/storage component 1306 may include volatile media (such as random access memory (RAM)) and/or nonvolatile media (such as read only memory (ROM), Flash memory, optical disks, magnetic disks, and so forth). The memory/storage component 1306 may include fixed media (e.g., RAM, ROM, a fixed hard drive, etc.) as well as removable media (e.g., a Flash memory drive, a removable hard drive, an optical disk, and so forth).

The one or more input/output interfaces 1308 allow a user to enter commands and information to computing device 1300, and also allow information to be presented to the user and/or other components or devices using various input/output devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer-readable media. The computer-readable media may include a variety of available medium or media that may be accessed by a computing device. By way of example, and not limitation, computer-readable media may comprise “computer-readable storage media.”

Software or program modules, including the auction flighting tool 116, applications 108, service manager module 112, operating system 110, and other program modules, may be embodied as one or more instructions stored on computer-readable storage media. The computing device 1302 may be configured to implement particular functions corresponding to the software or program modules stored on computer-readable storage media. Such instructions may be executable by one or more articles of manufacture (for example, one or more computing device 1302, and/or processors 1304) to implement techniques for auction flighting, as well as other techniques. Such techniques include, but are not limited to, the example procedures described herein. Thus, computer-readable storage media may be configured to store instructions that, when executed by one or more devices described herein, cause various techniques for auction flighting.

The computer-readable storage media includes volatile and non-volatile, removable and non-removable media implemented in a method or technology suitable for storage of information such as computer readable instructions, data structures, program modules, or other data. The computer-readable storage media can include, but is not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or another tangible media or article of manufacture suitable to store the desired information and which may be accessed by a computer.

Conclusion

Although the invention has been described in language specific to structural features and/or methodological steps, it is to be understood that the invention defined in the appended claims is not necessarily limited to the specific features or steps described. Rather, the specific features and steps are disclosed as example forms of implementing the claimed invention.

1. A computer-implemented method comprising:
designating a control group and a test group as distinct subgroups of participants who compete one to another in auctions online by partitioning a graph configured to represent interactions between the participants in auctions to optimize a number of interactions that occur between members in the control group and members in the test group;
conducting multiple auctions based upon whether participants include members associated with the test group, wherein:
test conditions are used for auctions of the multiple auctions that include participants from both the test group and the control group; and
control conditions are used for auctions of the multiple auctions that do not include members from the test group as participants; and
measuring a response to the test conditions by comparing behaviors of the participants in the auctions conducted with the control conditions to behaviors of participants in the auctions conducted with the test conditions.

2. The computer-implemented method of claim 1, wherein the multiple auctions comprise auctions for ad space that enables a service provider to show advertisements to clients in conjunction with resources from the service provider.

3. The computer-implemented method of claim 2, wherein the multiple auctions occur responsive to detection of requests from the clients to obtain resources from the service provider.

4. The computer-implemented method of claim 1, wherein the multiple auctions occur responsive to detection of search queries made by clients to a service provider to obtain search results through a search service accessible via the service provider.

5. The computer-implemented method of claim 1, wherein the control conditions and test conditions comprise one or more configurable settings for the multiple auctions.

6. The computer-implemented method of claim 5, wherein the one or more configurable settings for the multiple auctions include one or more of: a minimum price, a maximum price, a reserve price, a starting price, a bid increment, a time period for the auction, automatic bid settings, an auction type, or a number of bids allowed per bidder.

7. The computer-implemented method of claim 1, wherein measuring the response comprises calculating changes in one or more key performance indicators that result from the test conditions.

8. The computer-implemented method of claim 7, wherein the key performance indicators include revenue generated by the multiple auctions.

9. The computer-implemented method of claim 1, wherein conducting the multiple auctions comprises:
simulating requests for resources to initiate the multiple auctions;
parsing the requests to identify keywords related to the requests; and
ascertaining participants to compete in each of the multiple auctions for ad space associated with the resources according to the identified keywords.

10. The computer-implemented method of claim 1, wherein the number of interactions is expressed as a conductance value computed as a ratio of participations of members of the test group in the multiple auctions with members of the control group to a total number of participations in the multiple auctions.

11. One or more computer-readable storage media storing instructions that, when executed by one or more server devices, cause the one or more server devices to implement an advertising flighting tool configured to:
detect a resource request from a client device;
parse the resource request to identify keywords related to the resource request;
ascertain ad auction participants who compete for ad space based on the identified keywords;
selectively conduct an ad auction based upon whether the ascertained ad auction participants include members associated with a test group, wherein:
test conditions are used for the ad auction when members of the test group participate in the auction; and
control conditions are used for the ad auction when members of the test group do not participate in the ad auction.

12. One or more computer-readable storage media of claim 11, wherein the advertising flighting tool is further configured to:
collect data indicative of behaviors of the ad auction participants in auctions under both the test conditions and the control conditions; and
compare the behaviors of the ad auction participants under the test conditions and the control conditions to determine how the ad auction participants respond to the test conditions.

13. One or more computer-readable storage media of claim 11, wherein the resource request comprises a search query input via the client device to invoke search functionality made available by the search provider.

14. One or more computer-readable storage media of claim 11, wherein the keywords comprise search terms that form the search query.

15. One or more computer-readable storage media of claim 11, wherein the advertising flighting tool is further configured to:
provide requested resources to the client device in a manner that includes at least some advertisements that are selected based on the ad auction.

16. A computing system comprising:
one or more processors; and
computer readable storage media having one or more modules stored thereon, that, when executed via the one or more processors, cause the computing system to perform acts including:
dividing advertisers who compete one to another in auctions for ad space from a service provider into a control group and a test group that is designated to receive test conditions for auctions;
parsing a search query received through the service provider to identify keywords related to the search query;
selecting at least some of the advertisers to compete in an ad auction related to the search query based in part on the identified keywords;
determining when at least one advertiser from the test group is selected;
using the test conditions for the ad auction related to the search query when at least one advertiser from the test group is selected;
employing control conditions for the ad auction related to the search query when at least one advertiser from the test group is selected;
storing data indicative of behaviors of the advertisers in the ad auction related to the search query to enable analysis of advertiser behavior under the test conditions.

17. The computer system of claim 16, wherein the one or more modules, when executed via the one or more processors, further cause the computing system to perform acts including:
storing data describing associations of the advertisers to keywords such that advertisers are designated to participate in auctions corresponding to one or more keywords with which they are associated, and
referencing the data describing associations of the advertisers to keywords to perform the selecting of at least some of the advertisers by at least matching the advertisers to the identified keywords according to the stored associations of the advertisers to keywords.

18. The computer system of claim 16, wherein dividing the advertisers comprises identifying mutually isolated sub-markets corresponding to the advertisers and forming the control group and test group according to the mutually isolated sub-markets.

19. The computer system of claim 16, wherein dividing advertisers comprises selecting the control group and the treatment group based upon a conductance value defined as a ratio of participations of members of the test group in auctions with members of the control group to a total number of participations of the advertisers in the auctions.

20. The computer system of claim 16, wherein dividing advertisers further comprises partitioning a graph configured to represent interactions in auctions between the advertisers to minimize interactions that occur between members of the control group and members in the test group.
